(19) United States
(12) Patent Application Publication
(10) Pub. No.: US 2023/0160604 A1
(43) Pub. Date: May 25, 2023

(54) PUMPLESS TOP-UP WATER HEATING TANK

(71) Applicant: Mixergy Limited, Cassington, Oxfordshire (GB)

(72) Inventor: Peter ARMSTRONG, Cassington, Oxfordshire (GB)

(73) Assignee: Mixergy Limited, Cassington, Oxfordshire (GB)

(21) Appl. No.: 17/920,819

(22) PCT Filed: Apr. 23, 2021
(86) PCT No.: PCT/GB2021/050989

§ 371 Date: Oct. 24, 2022

(30) Foreign Application Priority Data
Apr. 24, 2020 (GB) 2006085.1
Jun. 4, 2020 (GB) 2008438.0

(51) Int. Cl. F24H 1/20; F24H 9/00; F24H 15/219

(52) U.S. Cl. CPC F24H 1/202; F24H 9/0021; F24H 15/219

(57) ABSTRACT

A water heating tank is provided comprising a reservoir with a cold water inlet into the reservoir and a hot water outlet from the reservoir. The water heating tank further comprises a heater enclosure located within the reservoir. The heater enclosure encloses at least part of a heater. The heater enclosure has an inlet, a vent and an outlet. The water heating tank further comprises a duct connected to the outlet of the heater enclosure. The duct has an exit located in an upper portion of the reservoir.

The present invention relates to a water heating tank and a method for operating it. In particular, a water heating tank with an electrical heating element that can heat relatively small quantities of water quickly and supply them without the use of a pump.

It is desirable to heat only the amount of water that is needed for use and it is desirable to be able to heat that water quickly, once a user has decided that they need it. In conventional water heating tanks the heating element is located at the base of the tank and when hot water is demanded by the user the cold water at the base of the tank is heated and rises to the top of the tank under the action of a convection current. There is inevitably mixing of the heated water as it rises through the tank therefore reducing the efficiency and speed with which a volume at hot water can be provided at the top of the tank from where is drawn off for use.

There is therefore a need for a water heating tank that can quickly and efficiently provide hot water to a user on demand.

Accordingly the present invention provides a water heating tank comprising a reservoir with a cold water inlet into the reservoir and a hot water outlet from the reservoir, a heater enclosure located within the reservoir, the heater enclosure enclosing at least part of a heater, the heater enclosure having an inlet, a vent and an outlet, a duct connected to the outlet and the duct having an exit located in an upper portion of the reservoir. This arrangement is advantageous because the heater enclosure encloses a relatively small volume of water. This enables sufficient heat to be imparted to that water by the heating element to cause the temperature of the water to be raised quickly to a temperature suitable for use (e.g. above 50 degrees Celsius). The duct facilitates the transfer of the heated water from the heater enclosure to the top of the tank, from where it will be drawn off for use, with the minimum of loss of temperature, because the heated water is shielded from the rest of the water in the tank by the wall of the duct.

Preferably, the vent of the heater enclosure is an enclosure vent that passes through a wall of the heater enclosure and that is covered by an openable enclosure vent cover and wherein there is also provided an actuator to open the enclosure vent.

The enclosure vent can provide a relief path once initial heating is achieved, to permit better heating in lower portions of the reservoir and to prevent excessive heating in the top of the reservoir and in the heater enclosure. The actuator is preferably configured to open the enclosure vent at least partially once a predetermined threshold temperature is reached at a specific location in the reservoir. Various combinations of suitable threshold temperature and specific location in the reservoir may be appropriate. For example, suitable specific locations may include: at a top of the reservoir, in the top half of the reservoir, in the top third of the reservoir, in the heater enclosure, in the duct, or in the reservoir at a particular height between the heater and the top of the duct. The predetermined threshold temperature may for example be one or more of: above 45° C., above 50° C., around 55° C., below 70° C., and below 60° C. The predetermined threshold temperature may be selected in dependence on the specific location in the reservoir.

The vent may be an enclosure vent. The enclosure vent may pass through a wall of the heater enclosure. The enclosure vent may be closed by an enclosure vent closure. An actuator may be provided to move the enclosure vent closure. The heater enclosure may comprise an enclosure vent closure suitable for closing the enclosure vent. The heater enclosure may comprise an actuator arranged to move the enclosure vent closure.

Preferably the actuator is a thermal actuator, such as a bimetallic actuator or a wax motor. Preferably, the actuator is a wax motor. For effective thermal response the bulb of the wax motor is preferably located inside the heater enclosure. For effective venting the bulb of the wax motor is preferably located within the top half of the heater enclosure. Preferably the actuator is configured to open the enclosure vent at least partially above a threshold temperature. The threshold temperature may be above 50° C., further preferably around 55° C. This can prevent water at the top of the reservoir from becoming too hot and water at the bottom of the reservoir from failing to become heated. Preferably the threshold temperature is below 70° C., further preferably below 60° C.

For effective venting the enclosure vent may be located above the heater. For effective venting the enclosure vent may be located near the heater, preferably near a top half of the heater or at or near a top of the heater. This can permit venting of water heated by the heater. For effective venting the enclosure vent may be located within 30 cm height or 20 cm height or 10 cm height above or below the top of the heater. For effective venting the enclosure vent is preferably located within the top half of the heater enclosure, more preferably at or near the outlet of the heater enclosure. For effective venting the enclosure vent may be located within 30 cm distance or 20 cm distance or 10 cm distance of the outlet of the heater enclosure. For effective fluid flow the outlet of the heater enclosure is preferably located at or near the top of the heater enclosure. For effective fluid flow the outlet of the heater enclosure is preferably located above a top of the heater.

Preferably, the water heating tank further comprises a cut-out thermostat for the heater, wherein the temperature sensor of the thermostat is located within the heater enclosure and above the heater. The temperature sensor is located above the heating element in order that it is located within the hottest zone of the heater enclosure. This is done to reduce the risk of water at a scalding temperature being drawn from the tank.

Alternatively, the temperature sensor of the thermostat could be located in an upper portion of the reservoir, above the exit from the duct.

Preferably, the water heating tank further comprises a temperature and pressure relief valve fluidly connected to the reservoir by a pipe, wherein the inlet to the pipe is located above the exit from the duct.

Preferably, the water heating tank further comprises a chimney valve that, in use, can prevent fluid flow from the heater enclosure to the duct or prevent fluid flow from the duct.

Preferably, the chimney valve is actuated by a wax motor. The wax motor may be located within upper region of the heater enclosure. The wax motor may also actuate the enclosure vent closure. The chimney valve may be actuated by the actuator of the heater enclosure.

The enclosure vent closure and the chimney valve may be provided by a combined valve. The wax motor may actuate the combined valve. The actuator of the heater enclosure may be arranged to actuate the combined valve.

In an alternative embodiment, the duct comprises at least one duct vent that passes through a wall of the duct and that is covered by an openable duct vent cover. There may also be provided a duct actuator to open the duct vent. The openable duct vent cover may be actuated by the actuator of the heater enclosure. The actuator of the heater enclosure may be arranged to actuate the openable duct vent cover.

Optionally the heater enclosure includes a plurality of enclosure vents.

Preferably, the enclosure vent is a hole. Preferably, the openable enclosure vent cover is an enclosure sleeve. Preferably the enclosure sleeve is located adjacent to the heater enclosure. Preferably the enclosure sleeve has an enclosure sleeve vent. Preferably the enclosure sleeve vent is a hole that passes through the wall of the enclosure sleeve.

Preferably, the at least one duct vent is a hole that passes through a wall of the duct. Preferably, the openable duct vent cover is a duct sleeve. Preferably, the duct sleeve is located adjacent to the duct. Preferably, the duct sleeve has a duct sleeve vent. Preferably, the duct sleeve vent is a hole that passes through the wall of the duct sleeve.

Preferably, the enclosure sleeve is moveable relative to the heater enclosure. The actuator of the heater enclosure may be arranged to move the enclosure sleeve relative to the heater enclosure. Preferably in one position there is no overlap of the enclosure vent and the enclosure sleeve vent and in another position there is at least some overlap of the enclosure vent and the enclosure vent sleeve.

Preferably the duct sleeve is moveable relative to the duct. The actuator of the heater enclosure may be arranged to move the duct sleeve relative to the duct. Preferably in one position there is no overlap of the duct vent and the duct sleeve vent. Preferably in another position there is at least some overlap of the duct vent and the duct sleeve vent. The duct sleeve may be fixed to the enclosure sleeve.

Preferably, the duct comprises a plurality of duct vents, the duct sleeve comprises a plurality of duct sleeve vents and wherein in one position a first group of the duct vents and a first group of the duct sleeve vents are aligned and in another position another group of the duct vents and another group of the duct sleeve vents are aligned. The configuration of overlapping vents in the duct and duct sleeve can be arranged to provide a flow path out of the side of the duct which drops progressively down the height of the duct as the thermocline within the tank is established and moves downwards through the cylinder. This approach maximises the conversion of electrical power to hot water which can be made available to a user at a useful temperature. In alternative embodiments, there may be fewer vents in the duct and/or duct sleeve. In these alternative embodiments, the first phase of heating develops hot water at a useful temperature up to the point where a maximum can temperature is reached, beyond which heated water is released into the cylinder underneath the thermocline where that heated water is mixed with cooler water located in the bottom of the tank. The approach of the alternative embodiments is not as optimal as the first, however it provides the advantage of reduced cost of manufacture of the water heating tank and the simplicity aids reliability by reducing the number of moving surfaces that are required in the more complex embodiments that are employed to achieve the most optimal dispatch of heated water into the cylinder. These embodiments assist with reducing the amount of energy needed to heat all of the water in the cylinder to a point at which it will be sterilised and in reduced the time taken to achieve the sterilisation temperature.

Preferably, the heater enclosure comprises at least one aperture towards its base, wherein the aperture acts as the inlet and the vent. Preferably, the heater enclosure has a heating zone within which zone there is located an active part of the heating element that is, in use, able to transfer heat to water within the heater enclosure and wherein the part of the aperture acting as the vent is located within the heating zone.

Preferably the water heating tank further comprises an openable aperture cover. This allows the area of the inlet region and/or the area of the vent region to be changed, thus allowing control of the temperature of the water within the heater enclosure. It is advantageous to be able to reduce the flow area in order to maximise the efficiency with which water within the heater enclosure can be heated. If the water within the heater enclosure is at a low temperature then it is advantageous to reduce the flow area so that the optimum amount of water travels up through the convective duct and loss of heat to the water at the bottom of the tank is minimised.

Preferably, the water heating tank further comprises a valve located at the inlet to the duct, at the outlet from the duct or within the duct. Advantageously, the valve is able to partially or fully close the duct.

Preferably, the degree of opening of the valve can be changed by an adjuster. The adjuster may be located at least partially outside of the reservoir. It is advantageous to have an external control because this facilitates changing the behaviour of the valve (e.g. the temperatures at which it opens and closes) after manufacture of the tank, whether in use, or immediately prior to installation in a hot water system.

Preferably, the water heating tank further comprises a second heater, wherein the second heater is located within the reservoir and externally to the heater enclosure. The second heater can be any suitable heater such as an electrical heating element, or it can be a coil of pipe supplied with hot water that has been heated by a gas boiler or by a heat pump. A heat pump can heat the water via a coil of pipe or via an external plate heat exchanger.

Preferably, the water heating tank further comprises a third heater, wherein the third heater is located within the reservoir and externally to the heater enclosure. The third heater can be any suitable heater such as an electrical heating element, or it can be a coil of pipe supplied with hot water that has been heated by a gas boiler or by a heat pump. A heat pump can heat the water via a coil of pipe or via an external plate heat exchanger. In one arrangement, the heat pump would heat the bulk of the water outside of the water heating tank to a low temperature. The arrangement of the heater enclosure and duct of the water heating tank to increase the temperature of relatively small amounts of water to a useable temperature, as and when they are demanded by a user.

Preferably, the water heating tank further comprises a hot water baffle located within the reservoir and positioned above the second heater.

Preferably, the water heating tank further comprises a thermostatic valve on the outlet. The provision of a thermostatic valve facilitates a reduction in the amount of time that it takes to raise the temperature of all of the water in the tank to, for example, a temperature needed to sterilise the water. In a conventional water heating tank, the temperature of the water should not exceed an upper limit, because if it does the risk of a user being scalded by the hot water is increased. In the water heating tanks of the present invention, if the maximum temperature of the water in the tank is limited to, for example 70 degrees Celsius, then it will take an undesirably long time to heat all of the water in the tank to a temperature that will cause it to be sterilised, e.g. when all of the water in the tank is above 60 degrees Celsius. This is because of the way that the tanks operate. The heating element is located within the can and the heated water rises to the top of the tank as a result of a convection current set up within the chimney. If the water in the top of the tank is not to exceed 70 degrees Celsius, then the heating element cannot be operated at full power continuously (if it is heated continuously the temperature of the water at the top of the tank will exceed 70 degrees Celsius). Instead, the heating element must be periodically switched off, or operated at a lower power. In the periods when the heating element is off, or operating at low power, a greater proportion of the heat within the water enclosed by the can and chimney passes into the water surrounding the can and chimney (rather than the water at the top of the tank). This may be via conduction through the walls of the can or the chimney or via water leaving the can through the flow ports. This enables the temperature of the water in the lower portions of the tank to be raised, but the time taken to raise the temperature is reduced because the heating element is not being operated continuously. If a thermostatic valve is provided then the water at the top of the tank can be allowed to exceed 70 degrees Celsius because the thermostatic valve will mix that water with water at a lower temperature thus ensuring that the water provided to the user is not at a temperature that is likely to scold them. If the water at the top of the tank can be allowed to exceed 70 degrees Celsius then the heating element can be operated at full power continuously, or at least for a greater period of time, thereby enabling the temperature within the tank to be raised to a sterilisation temperature more quickly.

Preferably, the reservoir comprises a base and the water heater is located adjacent to the base and extends into the reservoir away from the base.

Preferably, the duct has a lower cross-sectional area than the heater enclosure.

Preferably, the actuator is a wax motor. Preferably the wax reservoir of the wax motor is located within the heater enclosure, further preferably in its upper portion.

Preferably, the heater is an electrical water heater.

Preferably, the water heating tank further comprises a control system with a means for varying heat provided by the heater. The heater may be an electrical water heater and the control system may comprise means for varying a supply of electrical power to the heater. The control system is preferably adapted to cause the heater to provide heat until a first temperature threshold is crossed in the reservoir, preferably at the top of the reservoir. The first temperature threshold may be in the range of 65-75° C., preferably around 70° C. The control system may be adapted to control the heater to maintain a temperature in the reservoir (preferably a temperature at the top of the reservoir) in the region of the first temperature threshold. The control system is preferably adapted to cause the heater to stop providing heat until a second temperature threshold is crossed in the reservoir (preferably a temperature at the top of the reservoir). The second temperature threshold may be 1 to 10° C. below the first temperature threshold, preferably around 5° C. below the first temperature threshold. The second temperature threshold may be in the range of 60-70° C., preferably around 65° C.

Preferably, the water heating tank further comprises a diffuser at the duct exit in the upper portion of the reservoir. The diffuser may be co-axial with duct. The diffuser is preferably adapted to inhibit mixing of water exiting the duct with water in the top of the reservoir. The diffuser may be a plate diffuser or any other suitable diffuser.

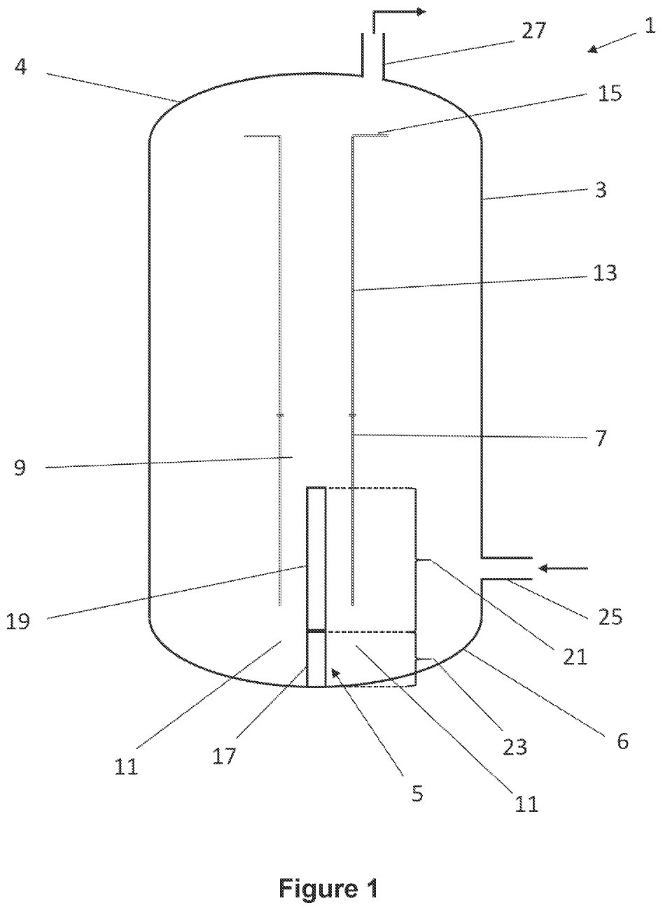

FIG. 1 is a schematic cross-sectional view of a water heating tank according to a first embodiment of the present invention;

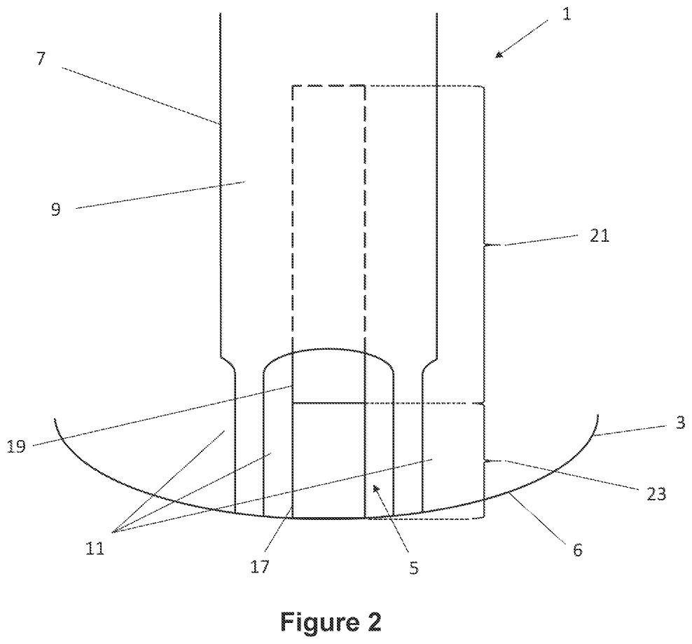

FIG. 2 is a view of the heating element enclosure of the water heating tank of FIG. 1 showing the flow ports;

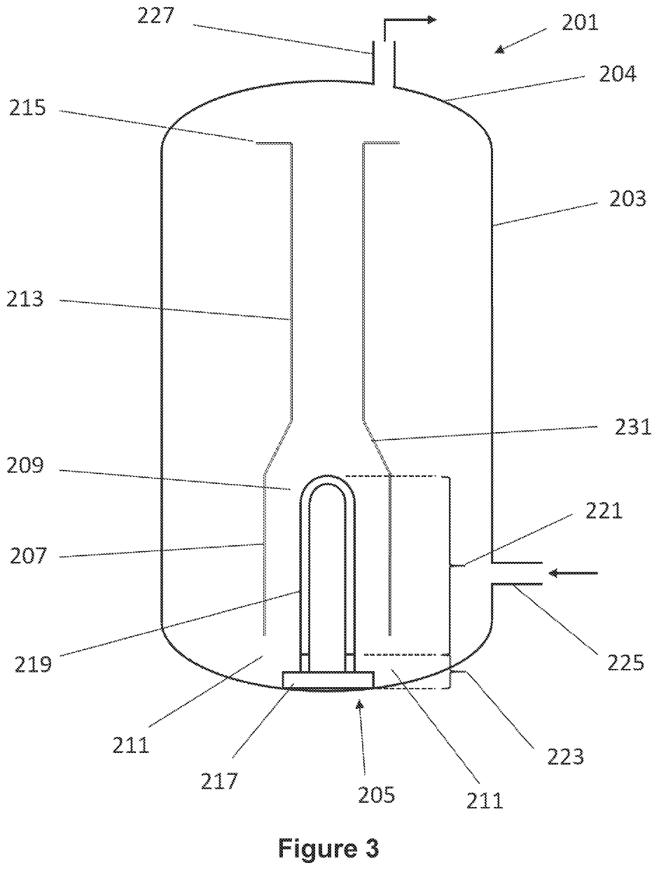

FIG. 3 is a schematic cross-sectional view of a water heating tank according to a second embodiment of the present invention;

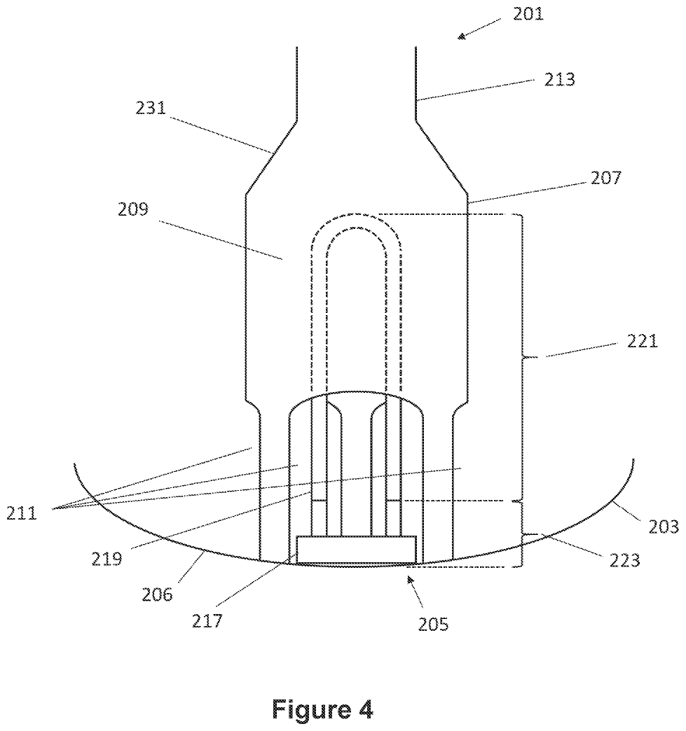

FIG. 4 is a view of the heating element enclosure of the water heating tank of FIG. 3 showing the flow ports;

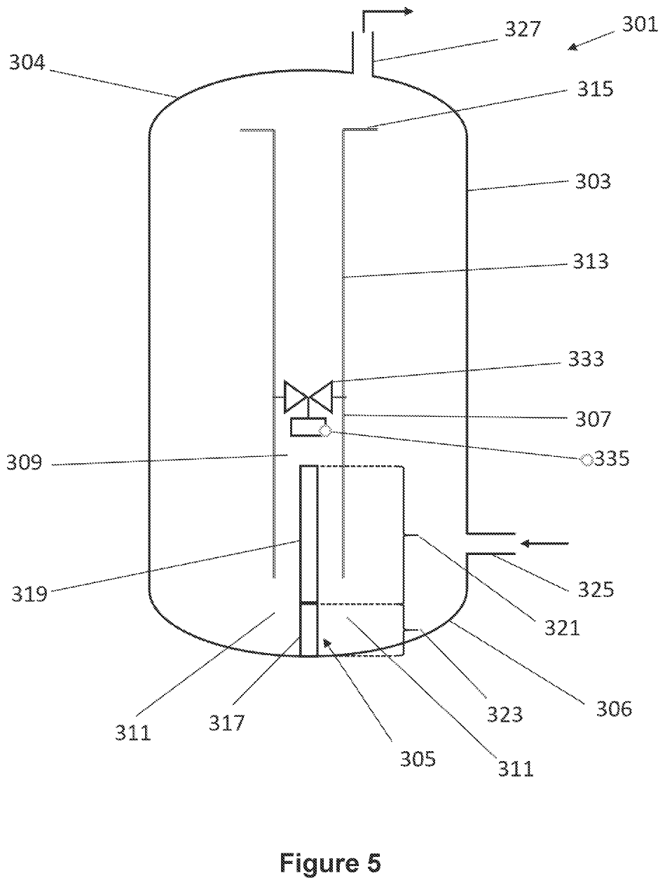

FIG. 5 is a schematic cross-sectional view of a water heating tank according to a third embodiment of the present invention;

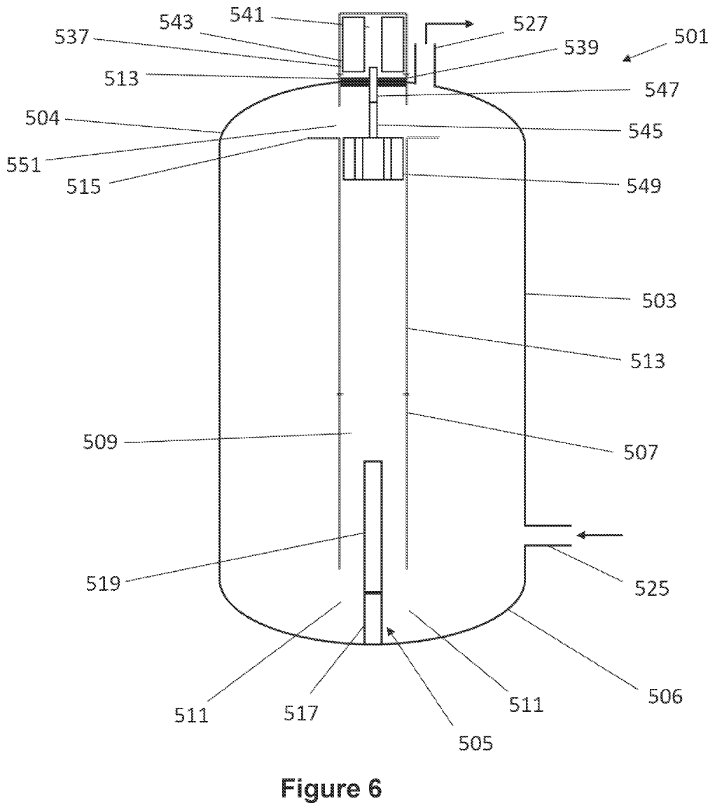

FIG. 6 is a schematic cross-sectional view of a water heating tank according to a fourth embodiment of the present invention;

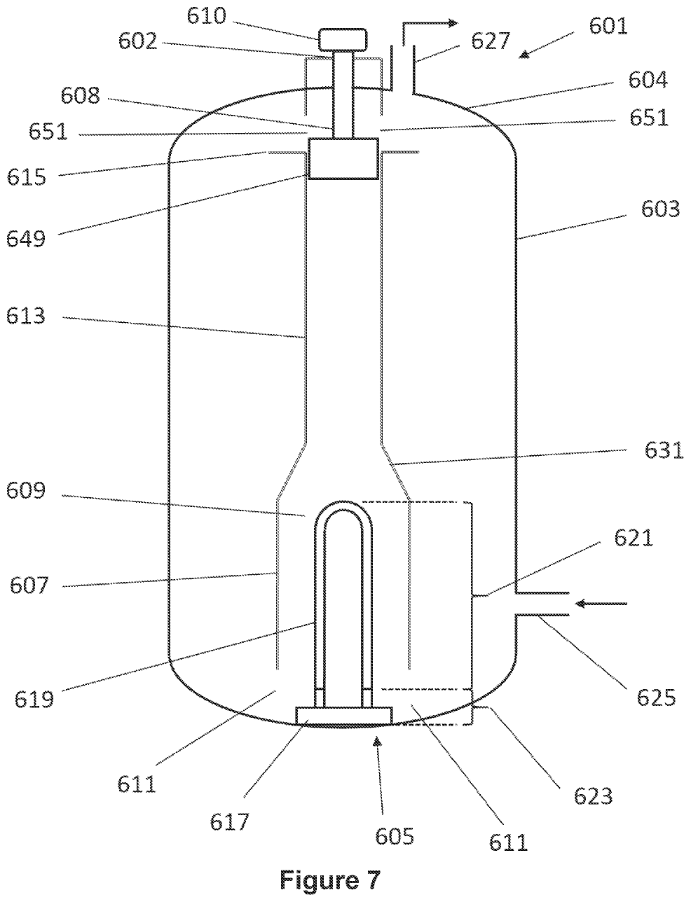

FIG. 7 is a schematic cross-sectional view of a water heating tank according to a sixth embodiment of the present invention;

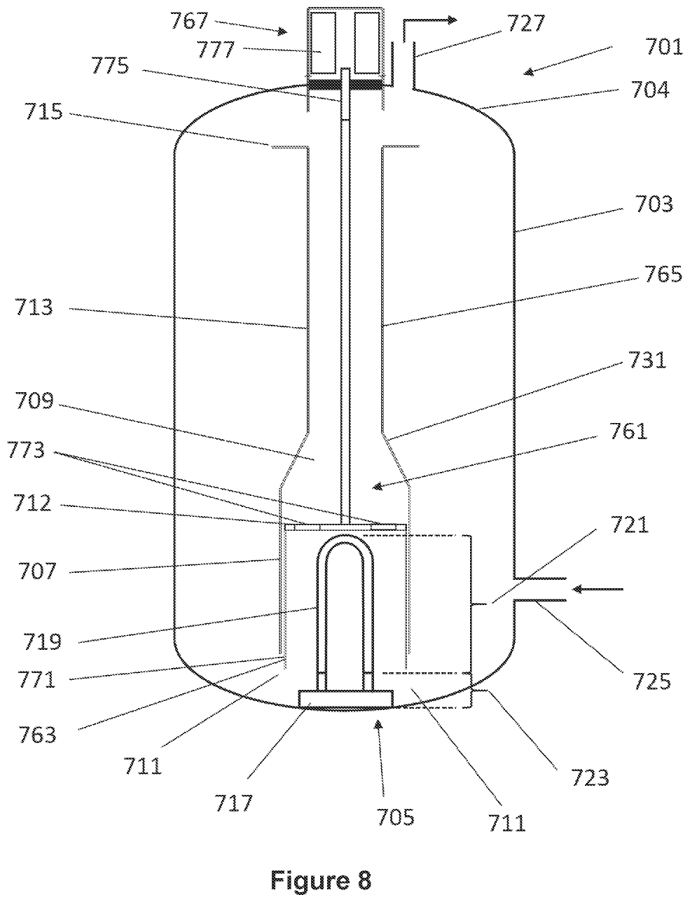

FIG. 8 is a schematic cross-sectional view of a water heating tank according to a seventh embodiment of the present invention with a mechanism for varying the flow area of flow ports in the heating element enclosure using a sliding sleeve;

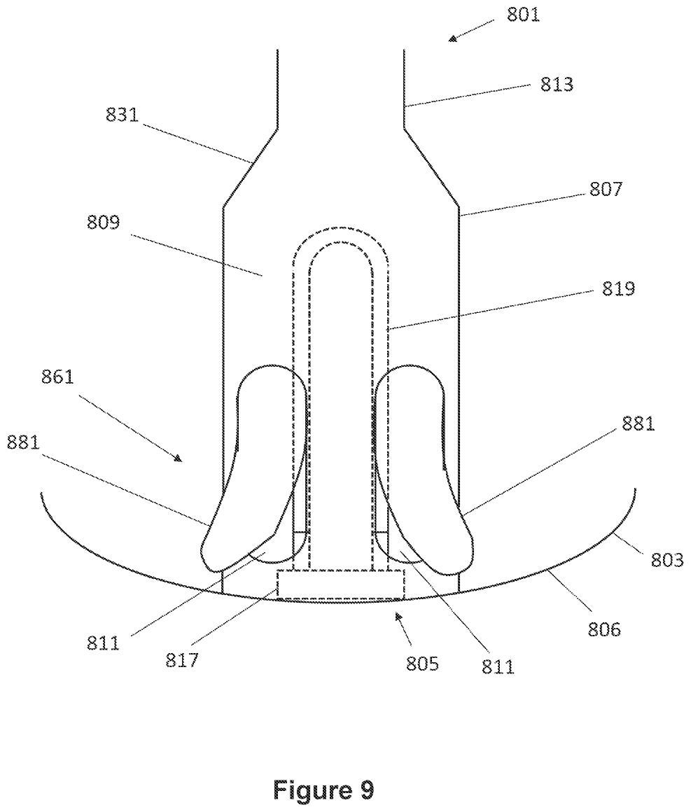

FIG. 9 is a schematic cross-sectional view of a heating element enclosure with a mechanism for varying the flow area of the flow ports using bimetallic elements;

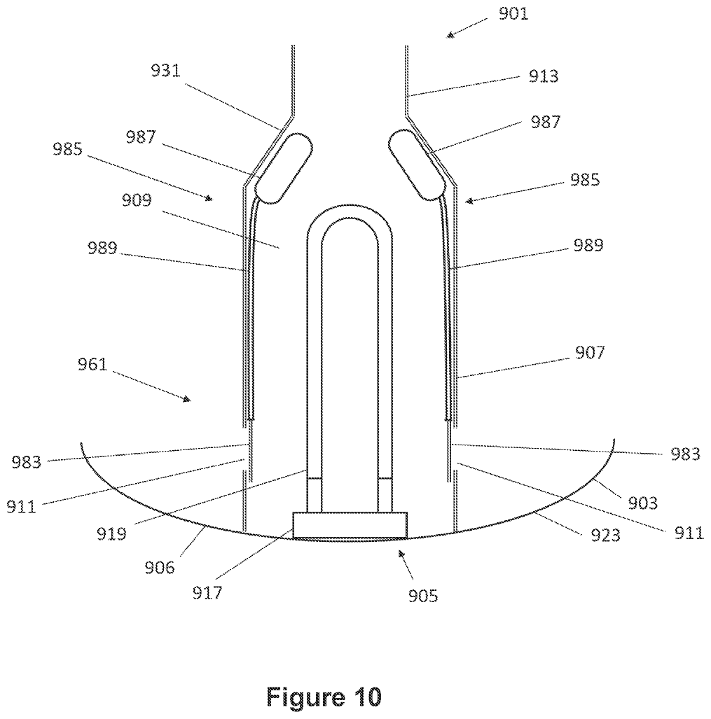

FIG. 10 is a schematic cross-sectional view of a heating element enclosure with a mechanism for varying the flow area of the flow ports using wax motors and sliding shutters;

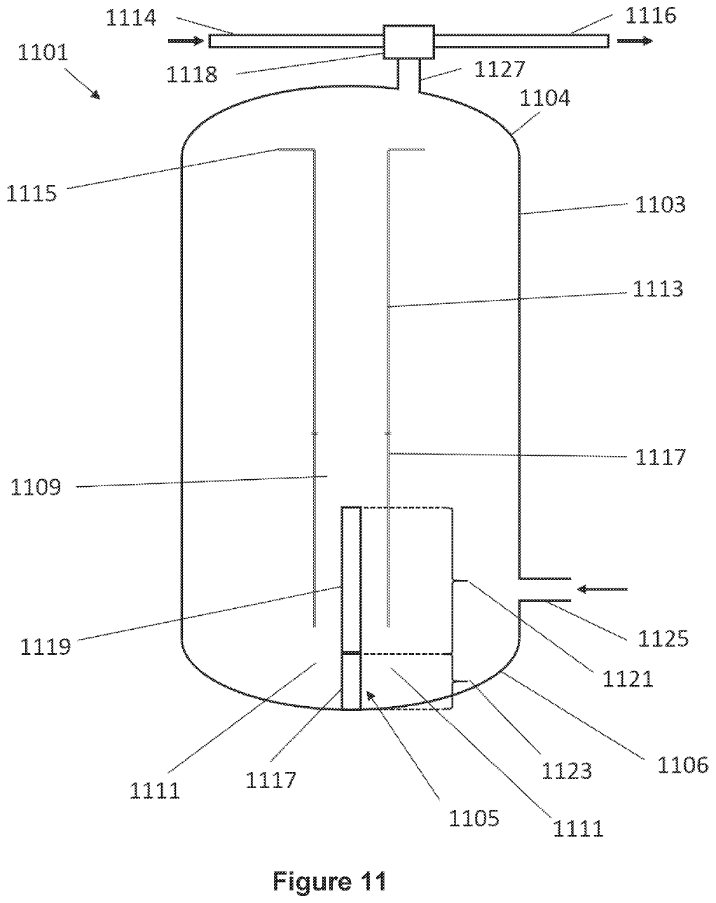

FIG. 11 is a schematic cross-sectional view of a water heating tank according to an eighth embodiment of the present invention, having a thermostatic valve;

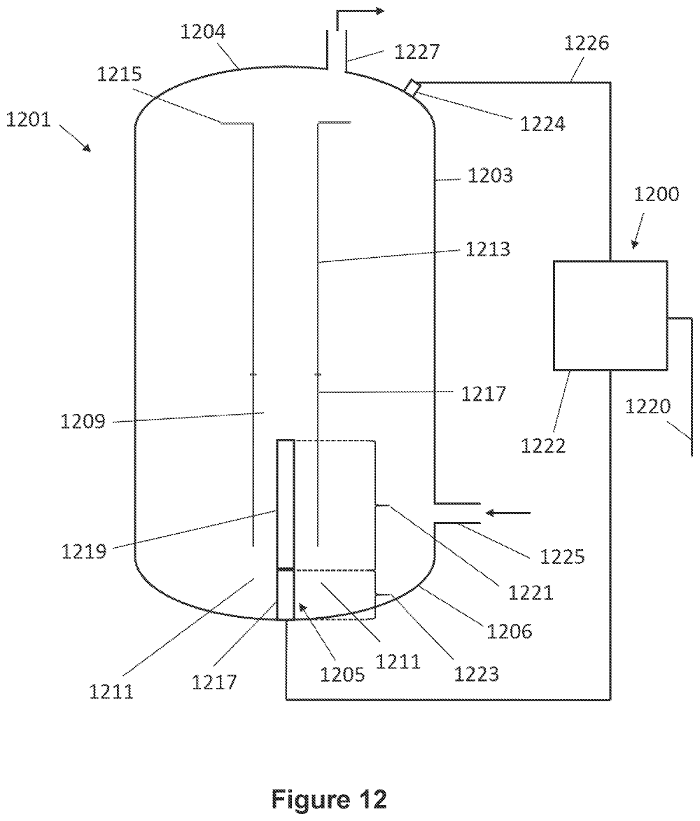

FIG. 12 is a schematic cross-sectional view of a water heating tank with a control system;

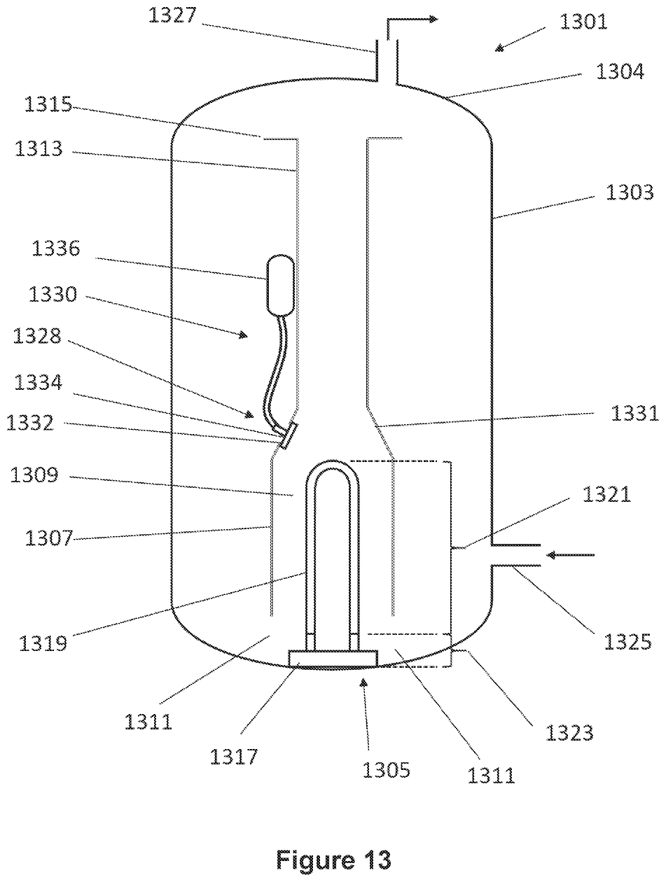

FIG. 13 is a schematic cross-sectional view of a water heating tank with an active hot water vent operated by a wax motor;

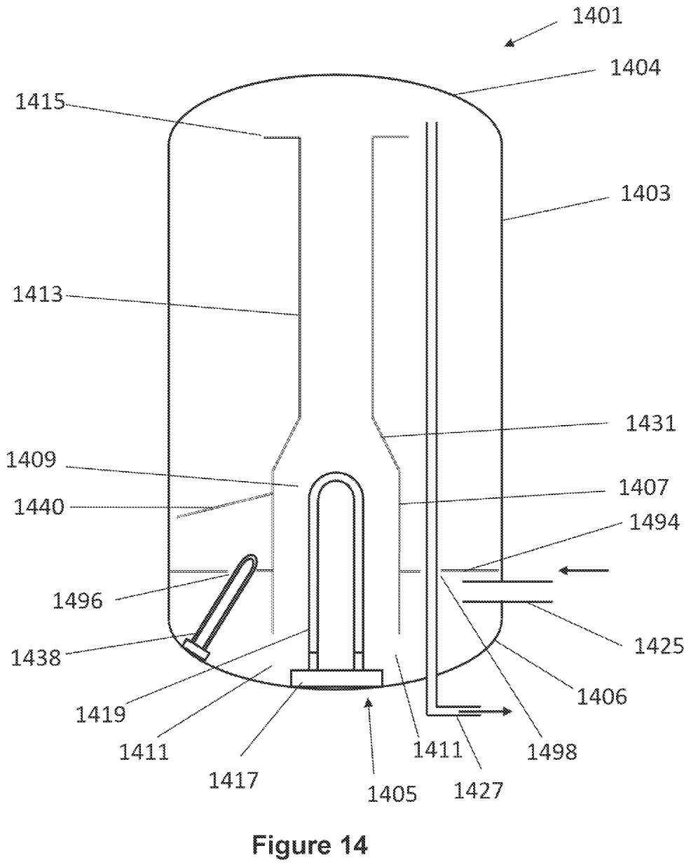

FIG. 14 is a schematic cross-sectional view of a water heating tank with a secondary heating element, hot and cold water baffles and a hot water outlet at the bottom;

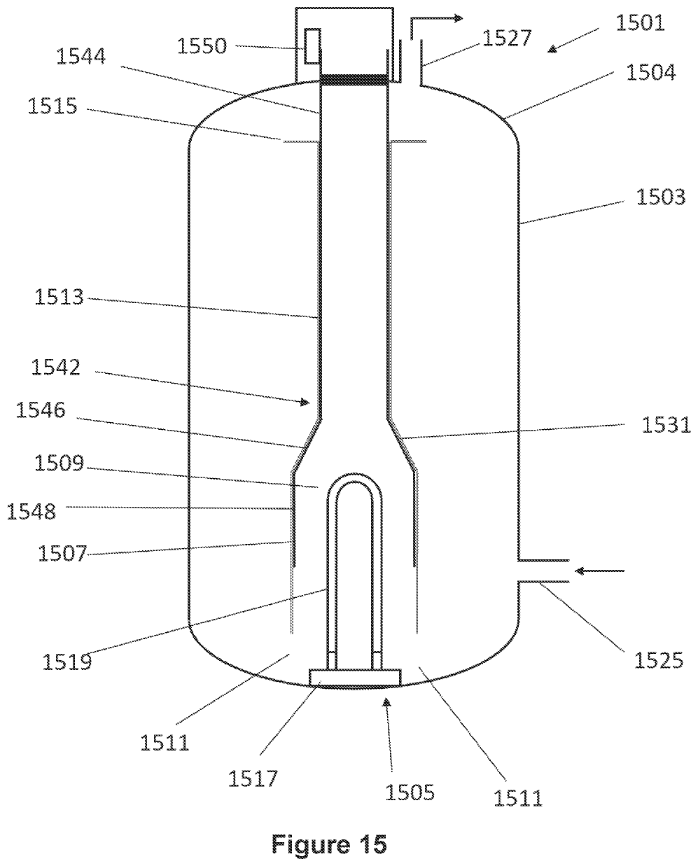

FIG. 15 is a schematic cross-sectional view of a water heating tank with a rotary hot water vent sleeve;

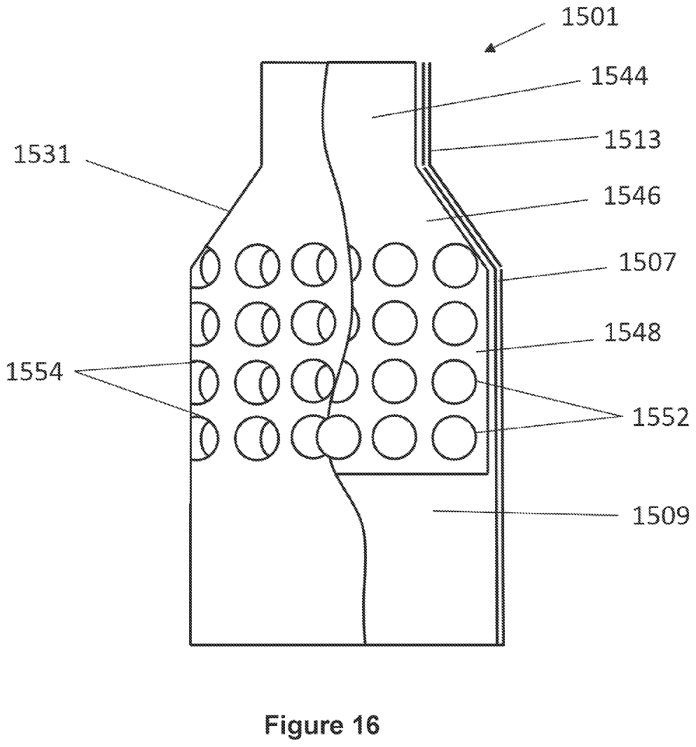

FIG. 16 is a partially cut-away close up view of the rotary hot water vent sleeve of FIG. 15;

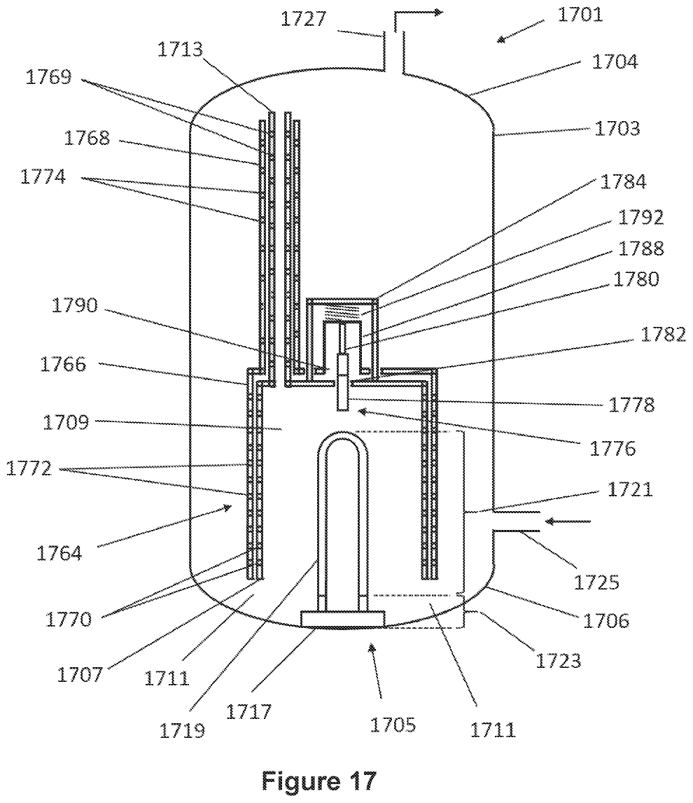

FIG. 17 is a schematic cross-sectional view of a water heating tank with a linearly displaceable hot water vent sleeve;

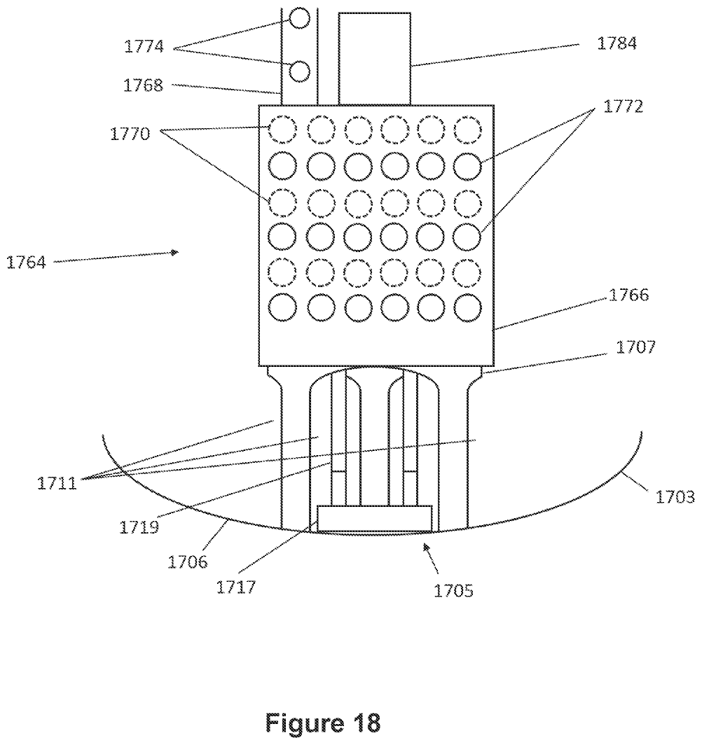

FIG. 18 is a schematic view of the can, chimney and linear hot water vent sleeve of FIG. 17;

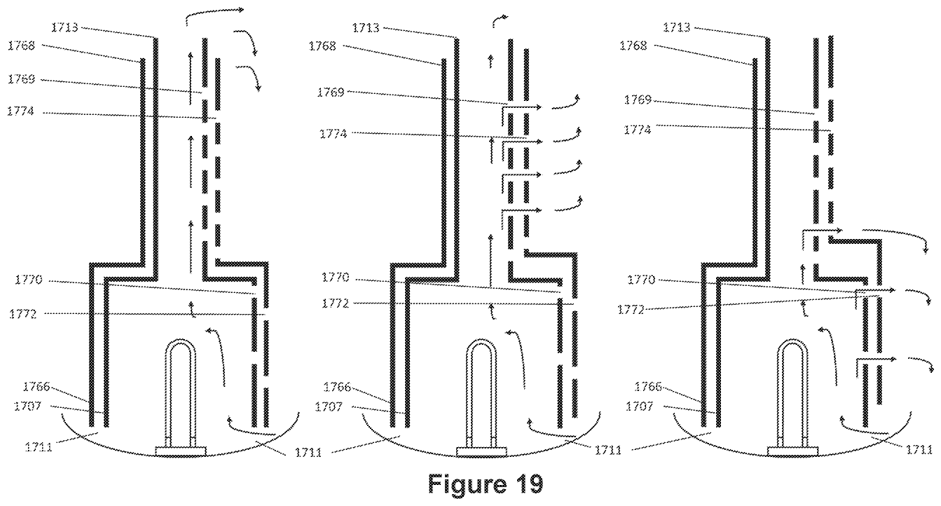

FIG. 19 is a diagram of flow through the can and chimney of the water heating tank of FIG. 17 when the can sleeve is in its bottom position, in a middle position and in its top position;

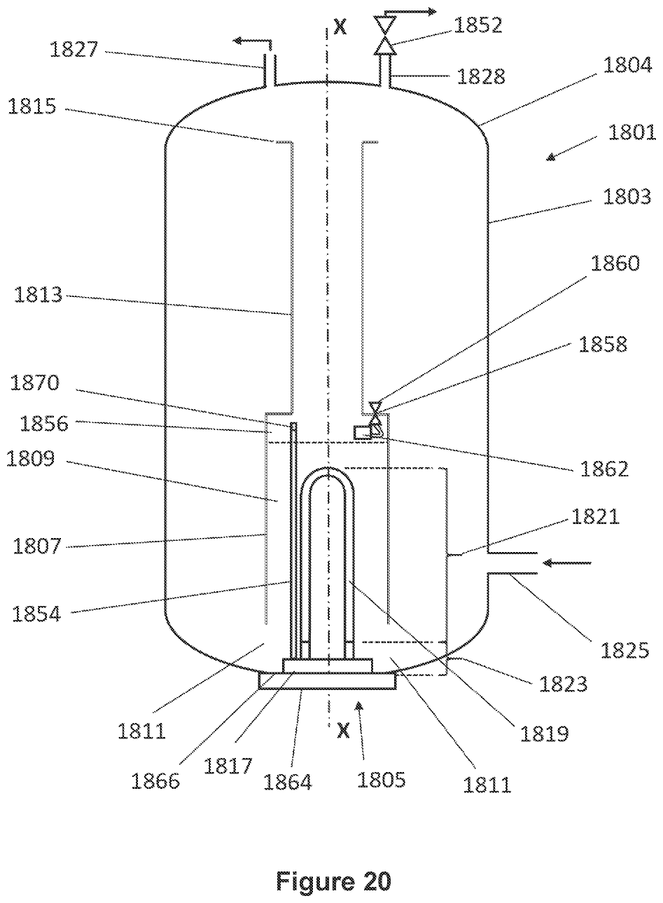

FIG. 20 is a diagram of a water heating tank with a temperature and pressure relief valve and a heating element cut-out thermostat; and

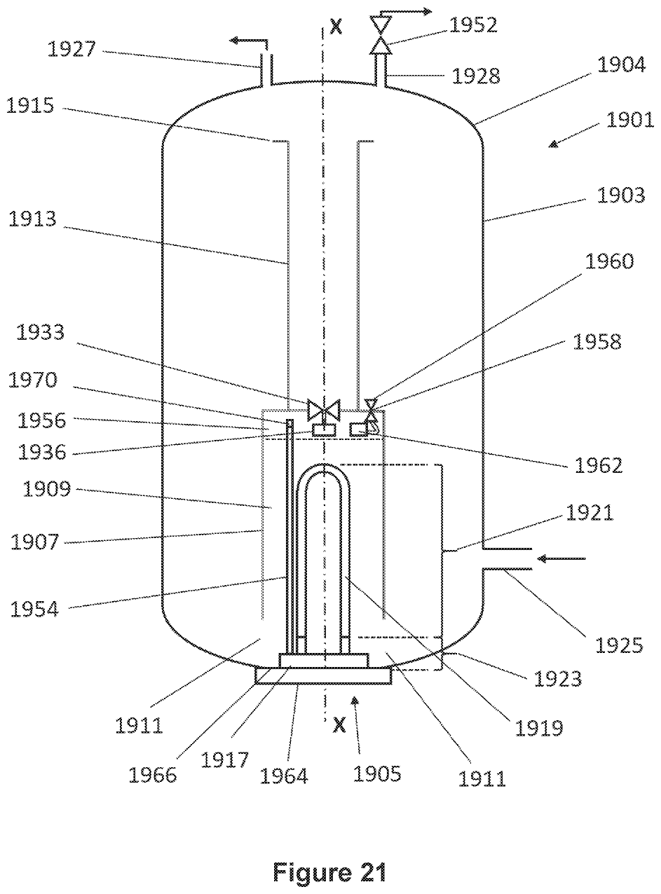

FIG. 21 is a diagram of a water heating tank with a temperature and pressure relief valve and a heating element cut-out thermostat and a chimney valve.

A water heating tank 1, for the provision of hot water, and according to a first embodiment of the present invention is illustrated in FIG. 1. The water heating tank 1 comprises a hollow cylinder 3 with a domed top wall 4 and a domed bottom wall 6. An electrical water heater 5 is located at the bottom of the cylinder 3, it is fixed to the bottom wall 6 and it is aligned with the longitudinal axis of symmetry of the cylinder 3. A tubular heating element enclosure, or can, 7 is located over the heater 5 and forms a heating zone 9. The can 7 has passive flow ports 11 arranged around the periphery of its lower portion. A tubular convective duct, or chimney, 13, extends vertically upwards from the top of the can 7 and co-axially with the can 7 and the cylinder 3. The can 7 and the chimney 13 each have a circular cross-sectional profile of constant diameter. The chimney 13 terminates close to the top surface of the cylinder 3. An annular plate, or diffuser, 15 is located at the top of the chimney 13 and co-axially with it.

The water heater 5 has a base 17 and a heating element 19. The base 17 is fixed to the bottom of the cylinder 3 and the heating element 19 extends vertically upwards from the base 17. The vertical height of the heating element 19 is less than the height of the can 7 and the top of the heating element 19 is located lower than the bottom of the chimney 13. The can 7 can be divided into an active zone 21, in which the heating element is located, and an inactive zone 23.

The passive flow ports 11 are arched and extend parallel to the axis X-X from the bottom of the cylinder 3 into the active zone 21.

The can 7, chimney 13 and diffuser 15 are made from a material that is approved for use with potable water, such as 316 stainless steel, or duplex or cross-linked polyethylene.

The cylinder 3 has a cold water inlet 25 and a hot water outlet 27.

In use, the cylinder 3 is filled with cold water via the cold water inlet 25 and power is provided to the electrical water heater 5. The electrical water heater 5 starts to heat the cold water within the can 7, within the heating zone 9. The temperature of the water increases, its density decreases and it rises upwards, through the can 7 and into the chimney 13. Cold water is drawn into the can 7 through the flow ports 11 to replace the water that is rising upwards.

When the heated water has passed up through the height of the chimney 13 it exits into the top of the cylinder 3. The diffuser 15 inhibits mixing of the hot water exiting the chimney 13 with the cold water in the top of the cylinder 3. A reduction in mixing facilitates the production of a volume of hot water at the top of the cylinder 3 that is sufficiently hot to be used.

Once a sufficient volume of hot water has been obtained the electrical water heater 5 is switched off.

Typically, the tank 1 only needs to produce a relatively small volume of hot water. However sometimes a larger quantity of hot water is desired and perhaps all of the water within the cylinder 3 may need to be heated. A thermocline will be created within the water in the cylinder 3, with the hottest water at the top of the cylinder 3 and the coldest water at the bottom of the cylinder 3. When the level of hot water has been pushed close to the bottom of the cylinder 3 it is no longer possible to create a convection current in the chimney 13, because the water passing into the can 7 is the same temperature as the water in the can 7. In this situation, the water heated within the can 7 by the electrical water heater 5 passes from the can 7 into the cylinder 3 through the passive flow ports 11.

A water heating tank 201 according to a second embodiment of the present invention is illustrated in FIG. 3. The tank 201 has features in common with tank 1 of the first embodiment and the common features utilise the same reference numerals prefixed with the number 2. In the second embodiment the electrical water heater 205 has a relatively large diameter and the can 207 thus has a larger diameter, so that it can enclose it. The chimney 213 has a relatively small diameter compared to the can 207 and a frustoconical tapering section 231 is provided between the outlet of the can 207 and the inlet of the chimney 213. FIG. 4 illustrates the passive flow ports 211 of the second embodiment.

The operation of the second embodiment of the present invention is the same as the operation of the first embodiment.

A water heating tank 301 according to a third embodiment of the present invention is illustrated in FIG. 5. The third embodiment is the same as the first embodiment except that the tank 301 has a valve 333 that is located between the outlet of the can 307 and the inlet to the chimney 313, in order to partially or fully close off the chimney 313 from the can 307. The valve 333 is driven by a wax motor 335.

In use, the valve 333 can be fully opened to allow substantially unimpeded flow of water from the can 307 into the chimney 313. The valve 333 can be fully closed to prevent flow of water from the can 307 into the chimney 313. The valve can be partially opened to restrict the flow of water from the can 307 into the chimney 313.

A fourth embodiment of the invention (not illustrated), is the same as the second embodiment except that the tank has a valve that is located between the outlet of the can and the inlet to the chimney, in order to partially or fully close off the chimney from the can.

The valves of the third and fourth embodiments can also be placed at, or near to, the outlet from the chimney.

A water heating tank 501 according to a fourth embodiment of the present invention is illustrated in FIG. 6.

The tank 501 shares many common features with the tank 1 of the first embodiment and those features are identified by the same reference numerals, pre-fixed with the number 5. A chimney 513 extends from the top of the can 507 through the cylinder 503 and through the top wall 504. The top of the chimney 513 is provided with an external screw thread onto which an internally screw threaded cap 537 is screwed. A sealing element 539 is located within the chimney 513 and creates a water-tight seal between the inside of the cylinder 503 and the inside of a chamber 541 which contains an electrical solenoid 543. A push-rod 545 passes through an aperture in the sealing element 539 and is connected at its top end to a core 547 of the solenoid 543. The bottom end of the push-rod 545 is connected to a plunger 549. The plunger 549 is located within the chimney 513 and the external surface of the plunger 549 is a close sliding fit with the inside surface of the chimney 513. The chimney 513 is provided with a number of outflow apertures 551 located around its circumference and adjacent to its top end. The length of the plunger 549 is slightly greater than the depth of the outflow apertures 551, measured in the direction of the longitudinal axis X-X. The outflow apertures 551 are located within the dome of the top wall 504.

The annular plate diffuser 515 is located on the chimney 513 just below the bottom edge of the apertures 551.

The outflow apertures 551 allow water to flow out of the chimney 513 into the top of the cylinder 503. In use, to control the flow of water out of the outflow apertures 551 the plunger 549 can be moved along the longitudinal axis X-X, by operation of the solenoid 543, so that the plunger 549 completely obscures the outflow apertures 551 to close them, partially obscures the outflow apertures 551 or is completely clear of the outflow apertures 551 so that they are fully open.

A water heating tank 601 according to a fifth embodiment of the present invention is illustrated in FIG. 7. The tank 601 shares many common features with the tank 201 of the second embodiment and those features are identified by the same reference numerals, pre-fixed with the number 6. A chimney 613 extends from the top of the can 607 through the cylinder 603 and through the top wall 604. The top of the chimney 613 is blanked off and provided with a central threaded aperture 602. A threaded control rod 608 of a thermostatic control knob 610 passes through the aperture and into the interior of the chimney 613 where it is connected to a thermostatic plunger 649. The chimney 613 is provided with a number of outflow apertures 651 located around its circumference and adjacent to its top end. The length of the thermostatic plunger 649 is slightly greater than the length of the outflow apertures 651. The outflow apertures 651 are located within the dome of the top wall 604. The annular plate diffuser 615 is located on the chimney 613 just below the bottom edge of the apertures 651.

The outflow apertures 651 allow water to flow out of the chimney 613 into the top of the cylinder 603. In use, to control the flow of water out of the outflow apertures 651 the plunger 649 can be moved along the longitudinal axis X-X, by rotation of the thermostatic control knob 610, so that the plunger 649 completely obscures the outflow apertures 651 to close them, partially obscures the outflow apertures 651 or is completely clear of the outflow apertures 651 so that they are fully open.

All of the above described embodiments of the tank 1,201,301 and 501 and the embodiments of the tank 1101, 1201, 1301, 1401, 1501 and 1701, as described below can also be provided with a means for changing the flow area of the passive flow ports 11,211,311 and 511 that pass through the walls of the can 7,207,307 and 507, such that they become active flow ports. FIGS. 8, 9 and 10 illustrate three variants of a variable flow port mechanism having active flow ports.

FIG. 8 shows a tank 701 according to a sixth embodiment of the present invention that is provided with a variable active flow port mechanism 761 that has a sleeve 763, a drive rod 765 and an electrical solenoid 767. The sleeve 763 is a sliding fit within the can 707 and is cup-shaped with a base 712 and a cylindrical side wall 771. The base 712 is provided with apertures 773 that allows water to pass from the inside of the sleeve 763 to the outside. The cylindrical side wall 771 is solid and continuous. The drive rod 765 is connected to the base 712 and extends perpendicularly from it, towards the top of the tank 701, along the longitudinal axis of the cylinder 703 until it passes through the top wall 704. A solenoid plunger 775 is attached to the top of the drive rod 765 and is located within the coil winding 777 of the electrical solenoid 767.

In use, energisation of the solenoid 779 causes the plunger 775 to be drawn into the coil winding 777, which lifts the drive rod 765 and thus the obturation sleeve 763. Lifting the obturation sleeve 763 increases the flow area of the flow ports 711. To reduce the flow area of the flow ports 711 the amount of electrical energy supplied to the solenoid 779 is decreased and the plunger 779, drive rod 765 and obturation sleeve 763 move downwards.

FIG. 9 shows a portion of a tank 801 that is provided with a can 807 having a variable active flow port mechanism 861. The variable active flow port mechanism 861 has bimetallic flaps 881 that are located within flow ports 811 and that are attached at their upper edges to the can 807.

In use, when the temperature of the water inside the can 807 is low the bimetallic flaps 881 are in plane with the wall of the can 807 and the flow ports 811 are closed. An increase in the temperature of the water within the can 807 causes the bimetallic flaps 881 to change shape and move out of the plane of the wall of the can 807, thus opening the flow ports 811. The behaviour of the bimetallic flaps 881 can be tuned so that the degree of opening of the flow ports 811 is appropriate to the temperature within the can 807 and thus the desired flow rate of water out of the can 807.

FIG. 10 shows a portion of a tank 901 that is provided with a variable active flow port mechanism 961 that has flow port shutters 983 and wax motors 985 having a wax bulb 987 and a linear actuator 989. The flow aperture shutters 983 are located within a can 907, adjacent to the flow ports 911, and are attached to the can 907 using slide rails.

In use, when the temperature of the water within the can 907 is low the wax within the wax bulb 987 is solid and at its minimum volume. An increase in the temperature of the water in the can 907 causes the wax to melt and expand. The increase in volume of the wax causes the linear actuator 989 to move the flow aperture shutters 983 from a position in which they are entirely covering the flow ports 911 to a position in which the flow ports 911 are partially open. If the temperature of the water within the can 907 is sufficiently high then the wax motors will move the flow aperture shutters 983 to an entirely opened position. The behaviour of the variable active flow port mechanism 961 can be tuned so that the degree of opening of the flow ports 911 is appropriate to the temperature within the can 907 and thus the desired flow rate of water out of the can 907.

A water heating tank 1101 according to a seventh embodiment of the present invention is shown in FIG. 11. The tank 1101 has the same features as the tank 1 of the first embodiment. In addition, it is provided with a thermostatic valve 1118 located on the hot water outlet 1127 of the cylinder 1103. The thermostatic valve 1118 has a cold water inlet pipe 1114 and an outlet pipe 1116.

A thermostatic valve, such as thermostatic valve 1118 can be fitted to the hot water outlets of any of the hot water tanks described herein and illustrated in FIGS. 1, 3, 5, 6, 7 and 8.

In operation of the water heating tank, the thermostatic valve 1118 is used to control, and typically to set an upper limit on, the temperature of the water leaving the outlet pipe 1116.

The present invention also encompasses a control system 1200 for controlling the input of heat into the water contained within the cylinder of a hot water tank, as illustrated in FIG. 12. The control system 1200 will be described with reference to a tank that is the same as tank 1 of FIG. 1, but it is equally applicable to any of the hot water tanks described herein and illustrated in FIGS. 1, 3, 5, 6, 7, 8, 11, 13, 14, 15 and 17. A power control unit 1222 is electrically connected to a mains electrical supply 1220 that supplies electrical power to a heating element 1219. A thermostat 1224 is mounted to the outside of the domed top wall 1204 of the reservoir 1203 and is electrically connected to the power control unit 1222 by a signal wire 1226.

In operation, when heating the water within the tank 1201 from cold, the power control unit 1222 is instructed to supply the heating element 1219 with power from the mains electrical power supply 1220. The power control unit 1222 knows to supply power to the heating element 1219 because the thermostat 1224 has indicated, via the signal wire 1226, that the temperature of the water at the top of the tank is too low. In an initial phase of heating the heating element 1219 is operated at full power and hot water is supplied to the top of the tank 1201 via the chimney 1213. The power control unit 1222 is programmed to supply power to the heating element 1219 until it receives a signal from the thermostat 1224 that the water at the top of the tank 1201 has reached a first temperature set point, e.g. 70 degrees Celsius. The power control unit 1222 then turns off the supply of power to the heating element 1219 or reduces the power supplied to the heating element 1219. When the power control unit 1222 receives a signal from the thermostat 1224 indicating that the water at the top of the tank 1201 has dropped below the first temperature set point by a predetermined number of degrees, for example the temperature has dropped to 65 degrees Celsius, then the power control until 1222 will turn back on the supply of power to the heating element 1219, or increase the power supplied to the heating element 1219.

Any of the hot water heating tanks described herein and illustrated in FIGS. 1, 3, 5, 6, 7, 8, 11, 13, 14, 15 and 17 can be operated with both a control system to control the supply of power to the heating element and a thermostatic valve attached to the hot water outlet from the tank.

FIG. 13 is a schematic diagram of a water heating tank 1301 according to an eighth embodiment of the present invention, provided with an active hot water vent 1328. The tank 1301 has all the features of tank 301 of the third embodiment, as illustrated in FIG. 3 and those features share the same reference numerals, prefixed with the number 13 instead of 2.

The active hot water vent 1328 is provided in the frustoconical tapered section 1331. A wax motor 1330 is attached to a vent cover 1332 located over a vent opening 1334. The wax motor bulb 1336 is located midway between the top of the can 1307 and the diffuser 1315. It should be noted that in other examples the wax motor bulb 1336 may be located elsewhere, for example nearer the diffuser, nearer the can, beside the can, within the can, within the chimney, above the diffuser, or at the top of the cylinder.

In use, power is supplied to the heating element 1319 and the water in the can 1307 is heated. This creates a convection current in the can 1307 and the chimney 1313 that causes cold water to be drawn into the can 1307 at the bottom, through the passive flow ports 1311, and to be pushed out of the top of the chimney 1313. The cylinder 1303 gradually fills up with hot water from the top, which pushes the thermocline down through the cylinder 1303 from the top to the bottom. The temperature of the water within the can 1307 increases as the thermocline moves down because of a change in the behaviour of the convection current. As the body of lighter hot water in the top of the cylinder increases, the hydrostatic buoyancy forces decrease and the flow rate through the can decreases. The temperature at the top of the cylinder and in the can may become too hot, while water at the bottom of the cylinder may not reach sanitary levels. The active hot water vent provides a relief path once initial heating is achieved, to permit better heating in lower portions of the cylinder and prevent excessive heating in the top part of the cylinder.

In order to prevent the can 1307 from overheating, which would cause the heating element 1319 to cut-out, the active hot water vent 1328 is opened, either fully or partially. The wax motor 1330 moves the vent cover 1332 away from the vent opening 1334. Hot water is vented from the can 1307 via the vent opening 1334. This venting of hot water creates a new convection current, with water still being drawn into the can 1307 through the passive flow ports 1311. This new convection current introduces heat into the bottom portion of the cylinder 1303, rather than to the top portion of the cylinder 1303.

The active hot water vent 1328 can be applied to any of the tanks of FIGS. 1, 3, 5, 6, 7, 8, 11, 12, 14, 15 and 17, as well as the tank of FIG. 13.

FIG. 14 is a schematic diagram of a water heating tank 1401 according to a ninth embodiment of the present invention, provided with a secondary heating element 1438. The tank 1401 has a number of the features of tank 201 of the second embodiment, as illustrated in FIG. 3 and those features share the same reference numerals, prefixed with the number 14 instead of 2.

The secondary heating element 1438 is located within the cylinder 1403, externally to the can 1407 and adjacent to it, and attached to the base 1406. A hot water baffle 1440 is attached to the external surface of the wall of the can 1407 and extends towards the wall of the cylinder 1403 to an extent such that it passes over the secondary heating element 1438. The hot water baffle 1440 is formed from a metal plate in the shape of the sector of a circle and it is provided with through holes (not shown). The hot water baffle 1440 is angled such that its edge attached to the can 1407 is vertically higher than its opposite edge.

A cold water baffle 1494 is attached to the external surface of the can 1407 and extends towards the wall of the cylinder 1403 to an extent that it passes across the secondary heating element 1438. An aperture 1496 is provided in the cold water baffle 1494 through which the secondary heating element 1438 can pass. A second aperture 1498 is provided in the cold water baffle through which a hot water outlet pipe 1427 can pass. The hot water outlet pipe has an inlet located above the outlet from the chimney 1413 and it passes out through the domed bottom wall 1406 of the cylinder 1403.

In use, power is supplied to the heating element 1419 and the water in the can 1407 is heated. This creates a convection current in the can 1407 and the chimney 1413 that causes cold water to be drawn into the can 1407 at the bottom, through the passive flow ports 1411, and to be pushed out of the top of the chimney 1413. The cylinder 1403 gradually fills up with hot water from the top. Power will be supplied to the heating element 1419 until the temperature of the water at the top of the cylinder reaches a preset level, for example 55 degrees Celsius. The supply of power to the heating element 1419 is then stopped and power is supplied to the secondary heating element 1438. The secondary heating element 1438 creates a convective plume in the water at the bottom of the tank and that plume is constrained by the hot water baffle in order that most of the heat emitted by the secondary heating element is absorbed by the water in the lower portion of the cylinder 1403.

The secondary heating element 1438 can be applied to any of the tanks of FIGS. 1, 3, 5, 6, 7, 8, 11, 12, 13, 15 and 17, as well as the tank of FIG. 1.

FIG. 15 is a schematic diagram of a water heating tank 1501 according to a tenth embodiment of the present invention, provided with a rotary hot water vent sleeve 1542. The rotary hot water vent sleeve 1542 is structured and arranged so that it can rotate within the can 1507 and the chimney 1513 by virtue of having a complementary chimney section 1544, frustoconical section 1546 and can section 1548. The chimney section 1544 extends through the domed top wall 1504 of the cylinder 1503 and is connected to an electric drive motor 1550. The frustoconical section 1546 and the can section 1548 are provided with interior vent holes 1552, as shown in FIG. 16. Exterior vent holes 1554 are provided in the can 1507 and in the frustoconical section 1531. The interior vent holes 1552 and the exterior vent holes 1554 are of the same diameter and are arranged in patterns such that in one position of the rotary hot water sleeve 1542 they are aligned, i.e. they are transposed over one another, or overlap one another, such that water can be vented from the can 1507 through the vent holes 1552, 1554, and in another position they are misaligned, such that water cannot be vented from the can 1507 through the vent holes 1552, 1554. The vent holes 1552, 1554 can also be partially aligned.

In use, power is supplied to the heating element 1519 and the water in the can 1507 is heated. This creates a convection current in the can 1507 and the chimney 1513 that causes cold water to be drawn into the can 1507 at the bottom, through the passive flow ports 1511, and to be pushed out of the top of the chimney 1513. The cylinder 1503 gradually fills up with hot water from the top, which pushes the thermocline down through the cylinder 1503 from the top to the bottom. The temperature of the water within the can 1507 increases as the thermocline moves down because of a change in the behaviour of the convection current. In order to prevent the can 1507 from overheating, which would cause the heating element 1519 to cut-out, the rotary hot water vent sleeve 1542 is rotated by the drive motor 1548 such that the vent holes 1552, 1554 are partially or fully aligned (dependent upon the amount of venting that is required). Hot water is vented from the can 1507 via the vent holes 1552, 1554. This venting of hot water creates a new convection current, with water still being drawn into the can 1507 through the passive flow ports 1511. This new convection current introduces heat into the bottom portion of the cylinder 1503, rather than to the top portion of the cylinder 1503.

FIG. 17 is a schematic diagram of a water heating tank 1701 according to an eleventh embodiment of the present invention, provided with a linear hot water vent sleeve 1764. The water heating tank 1701 shares a number of features with the tank 201 of the second embodiment, as illustrated in FIG. 3 and those features share the same reference numerals, prefixed with the number 17 instead of 2, as set out in the following description.

The water heating tank 1701 comprises a hollow cylinder 1703 with a domed top wall 1704 and a domed bottom wall 1706. The cylinder 1703 has a cold water inlet 1725 and a hot water outlet 1727. An electrical water heater 1705 is located at the bottom of the cylinder 1703, it is fixed to the bottom wall 1706 and it is aligned with the longitudinal axis of symmetry of the cylinder 1703. A tubular heating element enclosure, or can, 1707 is located over the heater 1705 and fixed to the bottom wall 1706. The can 1707 forms a heating zone 1709. The can 1707 is cup-shaped with a closed upper end and an open lower end. The can 1707 has three arch shaped passive flow ports 1711 that extend parallel to the longitudinal axis of the can and which are arranged around the periphery of its lower portion, at one hundred and twenty degree spacings, as shown in FIG. 18. A number of can perforations 1770 are provided through the upper portion of the can 1707. A tubular convective duct, or chimney, 1713, extends vertically upwards from the top of the can 1707. The longitudinal axis of the chimney 1713 is parallel to, but offset from, the longitudinal axis of the can 1707. The chimney 1713 has progressive chimney perforations 1769 along its length. The can 1707 and the convective chimney 1713 each have a circular cross-sectional profile of constant diameter. The chimney 1713 terminates close to the top surface of the cylinder 1703. A linear hot water vent sleeve 1764 is located over the can 1707 and chimney 1713. The linear hot water sleeve 1764 has a cup-shaped can sleeve 1766 that has a larger diameter than the can 1707 and a chimney sleeve 1768 that has a larger diameter than the chimney 1713. The can sleeve 1766 has a closed upper end and an open lower end and has can sleeve perforations 1772 around its entire cylindrical surface. The chimney sleeve 1768 has progressive chimney sleeve perforations 1774 along its length. The linear hot water sleeve 1764 is linearly slideable relative to the can 1707 and the chimney 1713 and the linear motion is driven by a wax motor 1776 that is attached to the top of the can 1707 and which extends into the heating zone 1709. The can 1707, the chimney 1713 and the hot water sleeve 1764 are made from a material that is approved for use with potable water, such as 316 stainless steel, or duplex or cross-linked polyethylene.

The water heater 1705 has a base 1717 and a heating element 1719. The base 1717 is fixed to the bottom of the cylinder 1703 and the heating element 1719 extends vertically upwards from the base 1717. The vertical height of the heating element 1719 is less than the height of the can 1707 and the top of the heating element 1719 is located lower than the bottom of the chimney 1713. The can 1707 can be divided into an active zone 1721, in which the heating element is located, and an inactive zone 1723. The passive flow ports 1711 extend into the active zone 1721.

The can perforations 1770 and the can sleeve perforations 1772 are of the same diameter and are arranged in arrays that are complementary, as shown in FIGS. 17 and 18, so that in one orientation there is no overlap between the can sleeve perforations 1772 and the can perforations 1770, in a second orientation there is a partial overlap between the can sleeve perforations 1772 and the can perforations 1770 and in a third orientation there is an exact alignment of the can sleeve perforations 1772 and the can perforations 1770. The perforations 1770 and 1772 are equally spaced within the arrays, in horizontal and vertical directions.

The chimney perforations 1769 pass through the wall of the chimney 1713 and are arranged in a vertical line between the top and the bottom of the chimney 1713. The chimney sleeve perforations 1774 pass through the wall of the chimney sleeve 1768 and are also arranged in a vertical line between the top and the bottom of the chimney sleeve 1768. The vertical spacings between the perforations 1769 and 1774 are not equal but are greater at the bottom than at the top and vary progressively inbetween. The spacings for the chimney perforations 1769 and the chimney sleeve perforations 1774 are the same.

The wax motor 1776 comprises a wax reservoir 1778 and an actuator rod 1780. The wax motor 1776 is attached to the top of the can 1707 and the reservoir 1778 extends through a can aperture 1782 at the centre of the top of the can 1707 into the heating zone 1709.

The can 1707 has a spring frame 1784 with two legs and a cross-bar fixed between the legs at their upper ends. The lower end of each leg is attached to the top of the can 1707, either side of the aperture 1782. The legs pass through frame apertures 1786 provided in the can sleeve 1776.

The can sleeve 1776 has an actuator frame 1788 with two legs and a cross-bar fixed between the legs at their upper ends. The lower end of each leg is attached to the top of the can sleeve 1776 either side of a can sleeve aperture 1790 through which the wax motor 1776 extends.

The actuator frame 1788 is located within the spring frame 1784 and the height of the legs of the actuator frame 1788 is less than the height of the legs of the spring frame 1784. This creates a vertical gap between the cross-bar of the actuator frame 1788 and the cross-bar of the spring frame 1784 and a return spring 1792 is located within that vertical gap and is attached at either end to a cross-bar.

In use, the cylinder 1703 is filled with cold water via the cold water inlet 1725 and power is provided to the electrical water heater 1705 in an initial water heating phase. The electrical water heater 1705 starts to heat the cold water that is located within the heating zone 1709 of the can 1707. The temperature of the water increases, its density decreases and it rises upwards, through the can 1707 and into the chimney 1713. Cold water is drawn into the can 1707 through the flow ports 1711 to replace the water that is rising upwards. In this stage of the operation the can sleeve 1766 and the chimney sleeve 1768 are in their lowermost position and there is no overlap between the can sleeve perforations 1772 and the can perforations 1770 or between the chimney sleeve perforations 1774 and the chimney perforations 1769. Therefore, during this initial heating stage, all of the water that is heated within the can 1707 passes out of the can 1707, through the chimney 1713 and into the upper portion of the cylinder 1703.

If only a small volume of hot water is required, then all of the water heating will take place within the initial heating phase. The power supply to the heating element 1705 will be switched off before there is a need to move to a subsequent phase of heating.

If a large volume of hot water is required, for example more than half a tank (or the whole tank, if a sterilisation cycle is being conducted) then one or more additional water heating phases will be needed, as explained below.

Water heated within the can 1707 will pass up the chimney 1713 and into the upper region of the cylinder 1703. The cylinder 1703 will gradually fill up with hot water from the top and as the level of hot water progresses downwardly through the tank the temperature of the water within the can 1707 will increase. This is because the hot water within the can 1707 is only able to rise due to convection if the temperature of the water above it is lower. In the initial heating phase, when the water at the top of the tank 1701 might be at 15 degrees Celsius, the temperature of the water leaving the can and passing up through the chimney is relatively low, i.e. below 50 degrees Celsius. When the water at the top of the tank 1701 is at a much higher temperature, for example at 50 degrees Celsius, the temperature of the water within the can 1707 will need to be raised to above 50 degrees Celsius, if the water in the can is to rise up the chimney 1713 by convection.

Eventually, the temperature of the water in the can 1707 will be elevated to a level at which the power supply to the heating element 1705 must be cut off in order to stop the heating element 1705 from overheating (which may cause it to fail). It is not desirable to have to cut off the power supply to the heating element 1705 because then the time taken to heat the required amount of water will increase (typically the heating element 1705 will need to be switched on and off repeatedly until the water has been heated to the desired temperature). Consequently, it is necessary to implement a subsequent heating phase to follow the initial heating phase.

When the temperature of the water in the can 1707 has risen to a certain level the wax motor 1776 will start to operate. The water will have raised the temperature of the wax contained within wax reservoir 1778 and that wax will expand, causing the actuator rod 1780 to move vertically upwards thus moving the actuator frame 1788, the can sleeve 1766 and the chimney sleeve 1768 vertically upwards. This will cause the can sleeve perforations 1772 to overlap the can perforations 1770 and the chimney sleeve perforations 1774 to overlap the chimney perforations 1769. The temperature of the water in the can 1707 will determine the extent to which the wax motor 1776 moves the can sleeve 1766 and the chimney sleeve 1768 and thus the extent to which the perforations 1769, 1770, 1772, 1774 overlap. If the water temperature within the can 1707 is very high then there will be an alignment of the perforations, such that the maximum amount of water can leave the can 1707 through the perforations 1770, 1772 and into the surrounding water, rather than that water leaving the can 1707 through the chimney 1713. A lower temperature of water within the can 1707 will result in a partial overlap of the perforations 1769, 1770, 1772, 1774 with a resulting lower flow area available for water to leave the can 1707. The return spring 1792 acts to return the can sleeve 1766 and the chimney sleeve 1768 towards their lower position as the temperature of the water in the can 1707 decreases.

FIG. 19 is a diagram showing, in simplified terms, how water flows through the can 1707 and chimney 1713 of the water heating tank 1701, as illustrated in FIG. 17. The drawings only show flow for the right hand side of the can 1707 and chimney 1713. The flow for the left hand side would be the same, but has been omitted to aid the clarity of the drawings.

The image on the left hand side image shows the can sleeve 1766 in its lowermost position which is representative of the position of the can sleeve 1766 at the start of a heating cycle, when the water in the cylinder 1703 is cold. The can sleeve perforations 1772 are not aligned with the can perforations 1770 and the chimney sleeve perforations 1774 are not aligned with the chimney perforations 1769. In use, an electrical supply is provided to the heating element 1705 and the heating element 1705 starts to heat up the water in the heating zone 1709 of the can 1707. Water is drawn into the can 1707 through the flow apertures 1711 located around its base. A convection current is set up and hot water rises through the can 1707 and through the chimney 1713 and exits at the top of the chimney 1713 into the volume at the top of the cylinder 1703.

The central image shows the can sleeve 1766 in a mid-position, which is representative of the position of the can sleeve 1766 mid way through a heating cycle, when the water in the cylinder 1703 has been heated up and the thermocline is moving downwards through the cylinder 1703. The can sleeve perforations 1772 are not aligned with the can perforations 1770 but the chimney sleeve perforations 1774 in a central section of the chimney sleeve 1768 are aligned with adjacent chimney perforations 1769. In use, heated water flows up out of the can 1707 by convection and some of it exits the chimney 1713 via the chimney and chimney sleeve perforations 1769, 1774 thus passing into the water in the main body of the cylinder 1703. The rest of the heated water exits at the top of the chimney 1713 into the volume at the top of the cylinder 1703.

The image on the right hand side shows the can sleeve 1766 in its uppermost position which is representative of the position of the can sleeve 1766 towards the end of a heating cycle, when almost all of the water in the cylinder 1703 is hot. The can sleeve perforations 1772 are aligned with the can perforations 1770 and some of the chimney sleeve perforations 1774 in the bottom section of the chimney sleeve 1768 are aligned with the adjacent chimney perforations 1769. In use, a significant proportion of the heated water flows out of the can 1707 via the can and can sleeve perforations 1770, 1772, passing into the water at the bottom of the cylinder 1703. Some heated water does pass up through the can 1707 and into the chimney 1713 and that water exits the chimney 1713 via the chimney perforations 1769, 1774 thus passing into the water towards the bottom of the cylinder 1703.

A water heating tank 1801, for the provision of hot water, and according to a further embodiment of the present invention is illustrated in FIG. 20. The water heating tank 1801 comprises a hollow cylinder 1803 with a domed top wall 1804 and a domed bottom wall 1806. An electrical water heater 1805 is located at the bottom of the cylinder 1803, it is fixed to the bottom wall 1806 and it is aligned with the longitudinal axis of symmetry of the cylinder 1803. A tubular heating element enclosure, or can, 1807 is located over the heater 1805 and forms a heating zone 1809. The can 1807 has passive flow ports 1811 arranged around the periphery of its lower portion. A tubular convective duct, or chimney, 1813, extends vertically upwards from the top of the can 1807 and co-axially with the can 1807 and the cylinder 1803. The can 1807 and the chimney 1813 each have a circular cross-sectional profile of constant diameter. The chimney 1813 terminates close to the top surface of the cylinder 1803. An annular plate, or diffuser, 1815 is located at the top of the chimney 1813 and co-axially with it.

The water heater 1805 has a base 1817 and a heating element 1819. The base 1817 is fixed to the bottom of the cylinder 1803 and the heating element 1819 extends vertically upwards from the base 1817. The vertical height of the heating element 1819 is less than the height of the can 1807 and the top of the heating element 1819 is located lower than the bottom of the chimney 1813. The can 1807 can be divided into an active zone 1821, in which the heating element 1819 is located, and an inactive zone 1823.

The passive flow ports 1811 are arched and extend parallel to the axis X-X from the bottom of the cylinder 1803 into the active zone 1821.

The can 1807, chimney 1813 and diffuser 1815 are made from a material that is approved for use with potable water, such as 316 stainless steel, or duplex or cross-linked polyethylene.

The cylinder 1803 has a cold water inlet 1825 and a hot water outlet 1827.

A temperature and pressure relief valve 1852 is connected to an outlet 1828 from the cylinder 1803 and to a drain (not shown). A temperature sensor 1870 of a heating element cut-out thermostat 1854 is located within a hot water region 1856. The hot water region 1856 is at the top of the can 1807 and above the heating element 1819. The temperature sensor 1870 is located above the heating element, as illustrated in FIG. 20.

A vent opening 1858 is provided in the top of the can 1807, in the shoulder adjacent to the chimney 1813, and a vent valve 1860 is provided within it. The vent valve 1860 is operated by a wax motor 1862 which is located within the hot water region 1856. In an open position of the vent valve 1860 the vent opening 1858 is open. In a closed position of the vent valve 1860 the vent opening 1858 is closed.

The electrical water heater 1805, the can 1807, chimney 1813, diffuser 1815 and heating element cut-out thermostat 1854 are fixed to a standard sized flange 1864, as a sub-assembly 1868, and can be located within the cylinder 1803 through an assembly opening 1866.

In use, the cylinder 1803 is filled with cold water via the cold water inlet 1825 and power is provided to the electrical water heater 1805. The electrical water heater 1805 starts to heat the cold water within the can 1807, within the heating zone 1809. The temperature of the water increases, its density decreases and it rises upwards, through the can 1807 and into the chimney 1813. Cold water is drawn into the can 1807 through the flow ports 1811 to replace the water that is rising upwards.

When the heated water has passed up through the height of the chimney 1813 it exits into the top of the cylinder 1803. The diffuser 1815 inhibits mixing of the hot water exiting the chimney 1813 with the cold water in the top of the cylinder 1803. A reduction in mixing facilitates the production of a volume of hot water at the top of the cylinder 1803 that is sufficiently hot to be used. Once a sufficient volume of hot water has been obtained the electrical water heater 1805 is switched off.

Typically, the tank 1801 only needs to produce a relatively small volume of hot water. However sometimes a larger quantity of hot water is desired and perhaps all of the water within the cylinder 1803 may need to be heated. A thermocline will be created within the water in the cylinder 1803, with the hottest water at the top of the cylinder 1803 and the coldest water at the bottom of the cylinder 1803. When the level of hot water has been pushed close to the bottom of the cylinder 1803 it is no longer possible to create a convection current in the chimney 1813, because the buoyancy of the heated water is no longer enough to push the hot water at the top of the cylinder further down, i.e. hydrostatic buoyancy forces decrease and the flow rate through the can decreases. The temperature at the top of the cylinder and in the can may become too hot, while water at the bottom of the cylinder may not reach sanitary levels. The vent opening provides a relief path once initial heating is achieved, to permit better heating in lower portions of the cylinder and prevent excessive heating in the top part of the cylinder and the can.

After initial heating, the water heated within the can 1807 by the electrical water heater 1805 passes from the can 1807 into the cylinder 1803 through the passive flow ports 11. Also, the hot water can be vented from the can 1807 via the vent opening 1858. The wax motor 1862 is preset to open the vent valve 1860 when the temperature of the water within the can 1807 exceeds a threshold temperature, for example 65° Celsius.

The heating element cut-out thermostat 1854 is preset to switch the heating element 2019 off when the water at the top of the can 1807 reaches a predetermined temperature, typically 80° Celsius. The water heated within the can 1807 will rise to the top of the can 1807 and thus the hot water region 1856 contains the hottest water within the can 1807.

The temperature and pressure relief valve 1852 is also used to limit the temperature of the heated water. When the water within the cylinder 1803 exceeds a preset temperature then the temperature and pressure relief valve 1852 will open and the hot water will be vented to a drain (not shown) via the outlet 1828.

To assemble, maintain, or repair the water heating tank 1801 the sub-assembly 1868 can be removed and replaced via the assembly opening 1866.

A water heating tank 1901, for the provision of hot water, and according to a further embodiment of the present invention is illustrated in FIG. 21. The water heating tank 1901 has all the features of the water tank 1801 and those features are referred to with the same reference numerals, but prefixed with 19 rather than 18. In addition, the water heating tank 1901 has a chimney valve 1933 located at the base of the chimney 1913, at the interface between the can 1907 and the chimney 1913. The chimney valve 1933 is operated by a wax motor 1935 and the wax motor bulb 1936 is located with the hot water region 1956 of the can 1907. When the water in the can 1907 is cold, then the chimney valve 1933 will be closed. When the water in the can 1907 is hot, then the chimney valve 1933 will be open (or at least partially open).

The water heating tank 1901 has all the operational characteristics of the water heating tank 1801 with the additional possibility of closing the outlet from the can 1907 into the chimney 1913. When heating water from cold, the chimney valve 1933 will initially be closed. The heating element 1919 will heat the water in the can 1907 and when the temperature of the water in the hot water region 1956 reaches a preset temperature, for example 50° Celsius, the chimney valve 1933 will start to open, driven by the wax motor 1935. The chimney valve 1933 will be fully open when the temperature in the hot water region 1956 reaches a second temperature, for example 55° Celsius.

It is envisaged that the vent valve 1960 and the chimney valve 1933 could be operated by a single wax motor with its wax bulb located within the hot water region 1956.

In an alternative arrangement (not illustrated) the vent valve 1960 and the chimney valve 1933 could be combined into a single combined valve. The combined valve could be operated by a single wax motor, having a single piston, with the bulb of the wax motor located within the hot water region 1956.

In use, if the water within the water heating tank 1901 and the can 1907 is initially cold, then initially the combined valve will be closed, i.e. water cannot exit from the can 1907 via the vent 1958 or via the chimney 1913. The opening between the can 1907 and the chimney 1913 remains closed until water within the can 1907 reaches a temperature of 50° Celsius, at which point the wax motor opens the combined valve so that water is allowed to pass from the can 1907 into the chimney 1913. At first, the opening into the chimney 1913 would be partially opened by the wax motor and then, as the temperature of the water within the can 1907 increases, the opening into the chimney 1913 would be fully opened by the wax motor (for example when the temperature of water in the can 1907 reaches 55° Celsius). When the temperature of water in the can 1907 reaches 65° Celsius the wax motor will further move the combined valve so that it will open the vent opening 1958, so that hot water can exit the can 1907 via either the chimney 1913 or the vent opening 1958.

Variants

While in the examples provided above an annular plate diffuser is described, it should be appreciated that a wide variety of diffusers are suitable for arrangement at the top of the chimney to inhibit mixing of hot water exiting the chimney with cold water in the top of the cylinder.

In some of the examples provided above a wax motor is described as moving a cover (e.g. to open a vent) in response to being heated. It should be appreciated that locating the wax motor bulb at a suitable position can enable venting in response to certain occurrences, for example in response to excessive build up of heat within the can or elsewhere, or to movement of the thermocline below a certain position. A variety of suitable positions for the wax motor bulb are conceivable in addition to those described, for example outside the chimney or inside the chimney, near the diffuser, near the can, inside the can, and/or near the top of the can. As described above locating the wax motor bulb inside the can, near the top of the can or near the can outlet, can be particularly efficient as this can permit both proximity to the vent being actuated and effective venting, as well as responding to a build up of heat in the can.

1. A water heating tank comprising:
a reservoir with a cold water inlet into the reservoir and a hot water outlet from the reservoir,
a heater enclosure located within the reservoir, the heater enclosure enclosing at least part of a heater, the heater enclosure having an inlet, an outlet, an enclosure vent that passes through a wall of the heater enclosure, an enclosure vent closure suitable for closing the enclosure vent, and an actuator arranged to move the enclosure vent closure; and
a duct connected to the outlet of the heater enclosure, the duct having an exit located in an upper portion of the reservoir.

2. A water heating tank as claimed in claim 1, wherein the actuator is a wax motor.

3. A water heating tank as claimed in claim 2, wherein the bulb of the wax motor is located inside the heater enclosure and within the top half of the heater enclosure.

4. A water heating tank as claimed in claim in any one of claim 1, 2 or 3 further comprising a cut-out thermostat for the heater, wherein the temperature sensor of the thermostat is located within the heater enclosure and above the heater.

5. A water heating tank as claimed in any preceding claim, further comprising a temperature and pressure relief valve fluidly connected to the reservoir by a pipe, wherein the inlet to the pipe is located above the exit from the duct.

6. A water heating tank as claimed in any preceding claim, further comprising a chimney valve that, in use, can prevent fluid flow from the heater enclosure to the duct or prevent fluid flow from the duct.

7. A water heating tank as claimed in claim 6, wherein the chimney valve is actuated by the actuator.

8. A water heating tank as claimed in claim 7, wherein the enclosure vent closure and the chimney valve are provided by a combined valve and wherein the actuator is arranged to actuate the combined valve.

9. A water heating tank as claimed in any preceding claim, wherein the duct comprises at least one duct vent that passes through a wall of the duct and that is covered by an openable duct vent cover and wherein there is also provided a duct actuator to open the duct vent.

10. A water heating tank as claimed in any preceding claim, wherein the enclosure vent is a hole, the enclosure vent closure is an enclosure sleeve located adjacent to the heater enclosure, and wherein the enclosure sleeve has an enclosure sleeve vent which is a hole that passes through a wall of the enclosure sleeve.

11. A water heating tank as claimed in claim 9, wherein the enclosure vent is a hole, the enclosure vent closure is an enclosure sleeve located adjacent to the heater enclosure and having an enclosure sleeve vent which is a hole that passes through a wall of the enclosure sleeve, and wherein the at least one duct vent is a hole that passes through the wall of the duct, the openable duct vent cover is a duct sleeve located adjacent to the duct and having a duct sleeve vent which is a hole that passes through a wall of the duct sleeve.

12. A water heating tank as claimed in claim 10, wherein the enclosure sleeve is moveable relative to the heater enclosure and wherein in one position there is no overlap of the enclosure vent and the enclosure sleeve vent and in another position there is at least some overlap of the enclosure vent and the enclosure sleeve vent.

13. A water heating tank as claimed in claim 11 wherein the enclosure sleeve is moveable relative to the heater enclosure and the duct sleeve is moveable relative to the duct, wherein in one position there is no overlap of the enclosure vent and the enclosure sleeve vent and in another position there is at least some overlap of the enclosure vent and the enclosure vent sleeve and there is some overlap of the duct vent and the duct sleeve vent.

14. A water heating tank as claimed in claim 12 or claim 13, wherein the duct comprises a plurality of duct vents, the duct sleeve comprises a plurality of duct sleeve vents and wherein in one position a first group of the duct vents and a first group of the duct sleeve vents are aligned and in another position another group of the duct vents and another group of the duct sleeve vents are aligned.

15. A water heating tank as claimed in claim 1, wherein the heater enclosure comprises at least one aperture towards its base, wherein the aperture acts as the inlet and the vent and wherein the heater enclosure has a heating zone within which zone there is located an active part of the heating element that is, in use, able to transfer heat to water within the heater enclosure and wherein the part of the aperture acting as the vent is located within the heating zone.

16. A water heating tank according to claim 15, further comprising an openable aperture cover.

17. A water heating tank according to any preceding claim, further comprising a valve located at the inlet to the duct, at the outlet from the duct or within the duct.

18. A water heating tank according to claim 17, wherein the degree of opening of the valve can be changed by an adjuster located at least partially outside of the reservoir.

19. A water heating tank according to any preceding claim, further comprising a second heater, wherein the second heater is located within the reservoir and externally to the heater enclosure.

20. A water heating tank according to claim 19, further comprising a third heater, wherein the third heater is located within the reservoir and externally to the heater enclosure.

21. A water heating tank according any preceding claim, further comprising a hot water baffle located within the reservoir and positioned above the second heater.

22. A water heating tank according to any preceding claim, wherein the reservoir comprises a base and the water heater is located adjacent to the base and extends into the reservoir away from the base.

23. A water heating tank according to any preceding claim, wherein the duct has a lower cross-sectional area than the heater enclosure.

24. A water heating tank according to any preceding claim, wherein the heater is an electrical water heater.

25. A water heating tank according to any preceding claim, further comprising a control system with a means for varying heat provided by the heater.

26. A water heating tank according to claim 25, wherein the heater is an electrical water heater and the control system comprises means for varying a supply of electrical power to the heater.

27. A water heating tank according to any preceding claim, further comprising a diffuser at the duct exit in the upper portion of the reservoir.
